(19) United States
(12) Patent Application Publication
(10) Pub. No.: US 2026/0092766 A1
(43) Pub. Date: Apr. 2, 2026

(54) MEASUREMENT DEVICE, MEASUREMENT SYSTEM, AND METHOD FOR ERECTING STRUCTURE

(71) Applicant: NIKON CORPORATION, Tokyo (JP)

(72) Inventor: Takashi MIYAWAKI, Machida-shi (JP)

(73) Assignee: NIKON CORPORATION, Tokyo (JP)

(21) Appl. No.: 19/110,121

(22) PCT Filed: Dec. 26, 2023
(86) PCT No.: PCT/JP2023/046672

§ 371 Date: Mar. 10, 2025

(30) Foreign Application Priority Data
Dec. 26, 2022 (JP) 2022-208005

(51) Int. Cl. G01B 7/24; E04G 21/16

(52) U.S. Cl. CPC G01B 7/24; E04G 21/16

(57) ABSTRACT

A measurement device measuring deformation information of a measurement target for a predetermined direction that is parallel to a direction of gravity, the measurement device including: one pair of attachment parts separated in the predetermined direction and being able to be fixed to the measurement target; a connecting member connecting the one pair of attachment parts fixed to the measurement target and extending substantially parallel to the predetermined direction; and a strain sensor fixed to the connecting member and measuring deformation information of the connecting member for the predetermined direction, in which the one pair of attachment parts are able to move apart or come close to each other in the predetermined direction in accordance with deformation of the measurement target for the predetermined direction in a state of being fixed to the measurement target.

### TECHNICAL FIELD

The present invention relates to a measurement device, a measurement system, and a method for erecting a structure and, for example, relates to a measurement device that has an object formed from a magnetic material as a measurement target and measures strain of the measurement target in one direction, for example, a measurement system for buildings suitable for steel-frame erection work in steel-frame buildings, and a method for erecting structures that include multi-section columns.

Priority is claimed on Japanese Patent Application No. 2022-208005, filed Dec. 26, 2022, the content of which is incorporated herein by reference.

### BACKGROUND ART

In steel-frame buildings, while steel-frame columns (sectional columns) of multiple sections are sequentially stacked in a vertical direction, the steel-frame columns are connected through welding or bolting via joints. For this reason, when construction progresses, the weight of an upper structure is applied to the lower section columns, causing the height-direction dimension of the lower section columns to shrink. Thus, it is necessary to adjust the length (height) of the entire columns by increasing the length (a height-direction dimension) of upper section columns loaded on the upper side by an amount of reduction of the height-direction dimension of lower section columns. For this reason, obtaining an amount of shrinkage by measuring the length of lower section columns, adjusting the length of upper section columns, and placing an order at a production factory or the like is performed for each of times. In order to perform adjustment with high accuracy, it is essential to measure the length of steel-frame columns with high accuracy.

In measuring the length of steel frames, various devices classified as laser distance measuring devices are used as length measuring devices. However, construction sites have many obstacles such as floors, scaffolding, and nets, and devices are required to be used under outdoor installation environments with temperatures of −20° C. to 50° C., and thus, measurement using laser distance measuring devices is unlikely to be compatible with such installation environments.

On the other hand, a strain sensor module equipped with a semiconductor chip with a strain sensor, a chip mounting part, and a wiring substrate is known as a high-precision measuring device for measuring the strain of an object (for example, see Patent Document 1). However, a strain sensor module described in Patent Document 1 needs to be closely adhered to a measurement target using an adhesive or the like and thus is not suitable for steel-frame construction sites on which many steel-frame columns are set as measurement targets. The reason for this is that a significant amount of time and effort is required for an operation for attaching strain sensor modules to steel-frame columns.

In addition, in a case in which multiple strain sensor modules are simply attached to multiple steel-frame columns, it is difficult to effectively utilize measurement information of each strain sensor module.

### CITATION LIST

### Patent Document

Patent Document 1: Japanese Patent Application, Publication No. 2021-181942

### SUMMARY OF INVENTION

### Solution to Problem

According to a first aspect of the present invention, there is provided a measurement device measuring deformation information of a measurement target for a predetermined direction that is parallel to a direction of gravity, the measurement device including: one pair of attachment parts separated in the predetermined direction and being able to be fixed to the measurement target; a connecting member connecting the one pair of attachment parts fixed to the measurement target and extending substantially parallel to the predetermined direction; and a strain sensor fixed to the connecting member and measuring deformation information of the connecting member for the predetermined direction, in which the one pair of attachment parts are able to move apart or come close to each other in the predetermined direction in accordance with deformation of the measurement target for the predetermined direction in a state of being fixed to the measurement target.

According to a second aspect of the present invention, there is provided a measurement system of a building constructed by stacking structures in a direction of gravity, the measurement system including: management devices connected to each other through a network; and a plurality of the measurement devices according to the first aspect, in which each of the plurality of the measurement devices has a plurality of erected section columns as the measurement target and is fixed to the measurement target through the one pair of attachment parts in a direction in which the predetermined direction coincides with a longitudinal direction of the measurement target.

According to a third aspect of the present invention, there is provided a method for erecting a structure including columns of multiple sections, the method including: acquiring deformation information of lengths of section columns of sections up to an (n−1)-th section that becomes a lower section column with respect to an n-th section column of which erection has already ended based on a result of strain measurement of each lower section column up to the (n−1)-th section prior to erection of the predetermined n-th (n≥2) section column; correcting a design value of a length of the n-th section column with the acquired deformation information of all the lower section columns taken into account; manufacturing the n-th section column based on the design value after correction; and erecting the manufactured n-th section column on the (n−1)-th section column that is a lower section column with respect thereto.

### BRIEF DESCRIPTION OF DRAWINGS

FIG. 1 is a block diagram illustrating the entire configuration of a measurement system according to one embodiment that is used in construction of a steel-frame building.

FIG. 2 is a perspective view illustrating a device main body of a measurement device together with a sectional column that is a measurement target.

FIG. 3 Part (A) of FIG. 3 is a plan view of a device main body of a measurement device, and part (B) of FIG. 3 is a bottom view of the device main body of the measurement device.

FIG. 4 is a front view of the device main body of the measurement device.

FIG. 5 is a block diagram illustrating the configuration of a control system of a measurement device.

FIG. 6 is a diagram illustrating one example of a steel-frame building.

FIG. 7 is a flowchart illustrating a processing algorithm according to a program that is executed by a CPU of an arithmetic operation processing unit of a measurement device.

FIG. 8 is a flowchart illustrating a processing algorithm according to a program relating to measurement of the length of a column that is executed by a CPU of a server.

### DESCRIPTION OF EMBODIMENTS

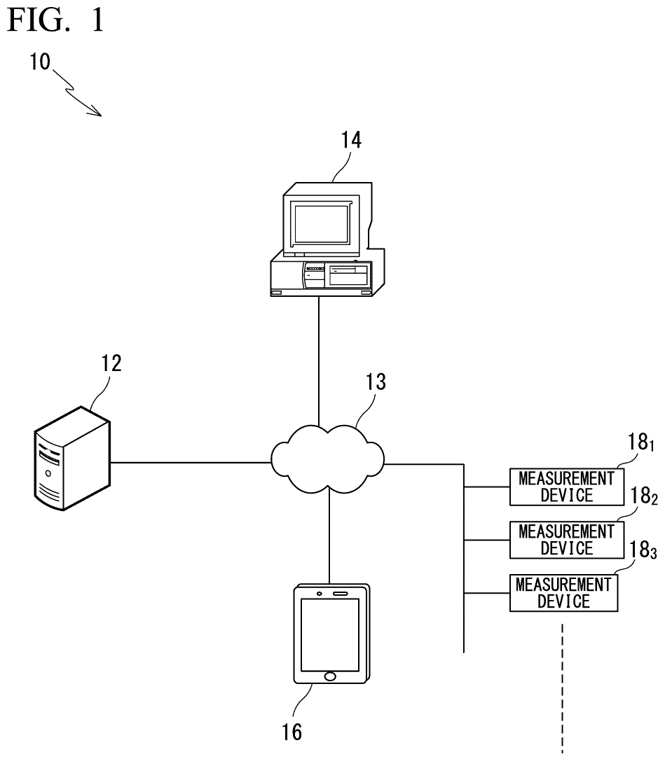

Hereinafter, one embodiment will be described with reference to FIGS. 1 to 8.

FIG. 1 is a block diagram illustrating the entire configuration of a measurement system 10 according to one embodiment that is used in erection of a steel-frame building.

The measurement system 10 is configured to include a server 12 that also functions as one of management devices connected through a wide area network (hereinafter, abbreviated to a network as is appropriate) 13, for example, such as the Internet, a field-side computer 14 as a manager-side terminal, a mobile terminal 16 as a worker-side terminal, and a plurality of measurement devices 18ᵢ (i=1, 2, . . . ).

Each of the plurality of measurement devices 18ᵢ is connected to the network 13 through a communication line, for example, a wireless LAN. FIG. 1 representatively illustrates three measurement devices 18₁ to 18₃ among the plurality of measurement devices 18ᵢ. All the communication lines may be wireless, or at least some thereof may be wired lines. The communication lines and the network 13 may be a part of the same network. Hereinafter, one network configured to include all of the network 13 and the communication lines connecting the server 12, the field-side computer 14, the mobile terminal 16, and the plurality of measurement devices 18ᵢ to the network 13 will be denoted by a network (a communication network) 13 using the same reference numeral as that of the wide area network 13. In this embodiment, a configuration in which outputs of the plurality of measurement devices 18ᵢ are directly provided for the server 12 through the network 13 is employed. However, a configuration in which outputs of the measurement devices 18ᵢ are provided for the server 12 through another terminal device such as the field-side computer 14 or the like connected to a network may be employed.

As the server 12, in this embodiment, although a computer for a server that is generally used is used, a cloud (computer) may be used. The server 12 includes a CPU, a ROM, a RAM, an HDD, and the like (storage) not illustrated in the drawing, and the CPU, for example, executes various processing algorithms defined using various programs stored in the ROM, the HDD, and the like by using the RAM as a work area. The configuration of the server 12 also functioning as a management device is not limited to this embodiment. In addition, the management device is not limited to hardware as in this embodiment and, for example, may be software capable of executing at least arithmetic operation functions.

As the field-side computer 14, a computer that is generally used is used in this embodiment. The field-side computer 14 includes an operation unit such as a keyboard and a mouse and a display unit such as a liquid crystal display. The field-side computer 14 performs data communication with other terminal devices (the server 12, the mobile terminal 16, and the like) connected to the network 13 through the network 13 in accordance with an instruction input by a field director or another field manager through the operation unit. As the manager-side terminal, the field-side computer 14 may not be necessarily disposed. In such a case, the field-side computer 14 may be substituted with the mobile terminal 16. As the field-side computer 14, a mobile terminal similar to the mobile terminal 16 may be disposed.

The mobile terminal 16 is held by a worker of a construction site (hereinafter, also referred to as a site worker or a worker). As the mobile terminal 16, a smartphone is used as one example. In addition, the mobile terminal may be a generally-used portable computer, for example, such as a tablet PC.

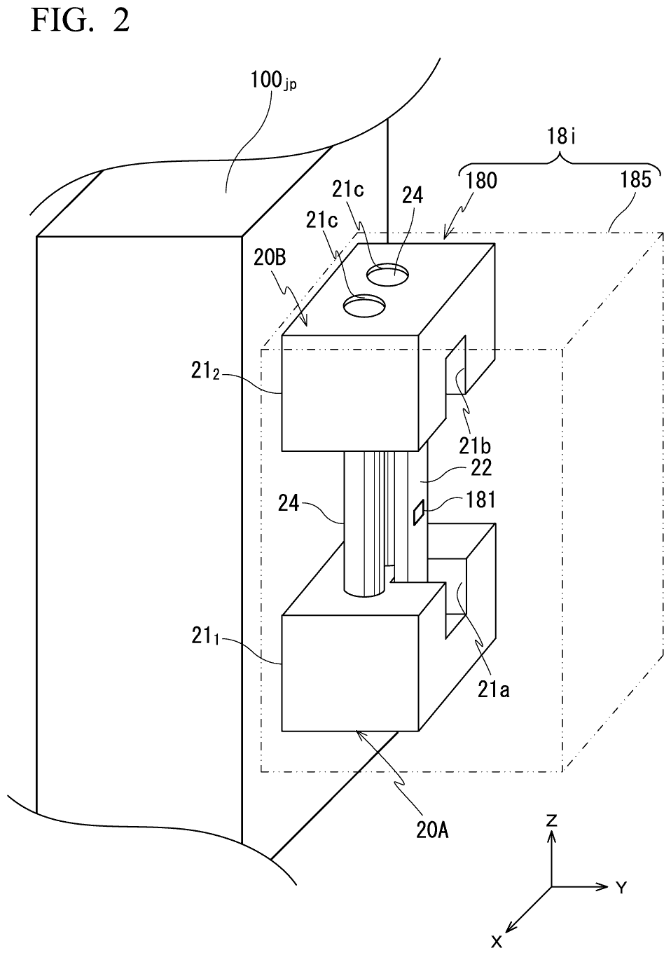

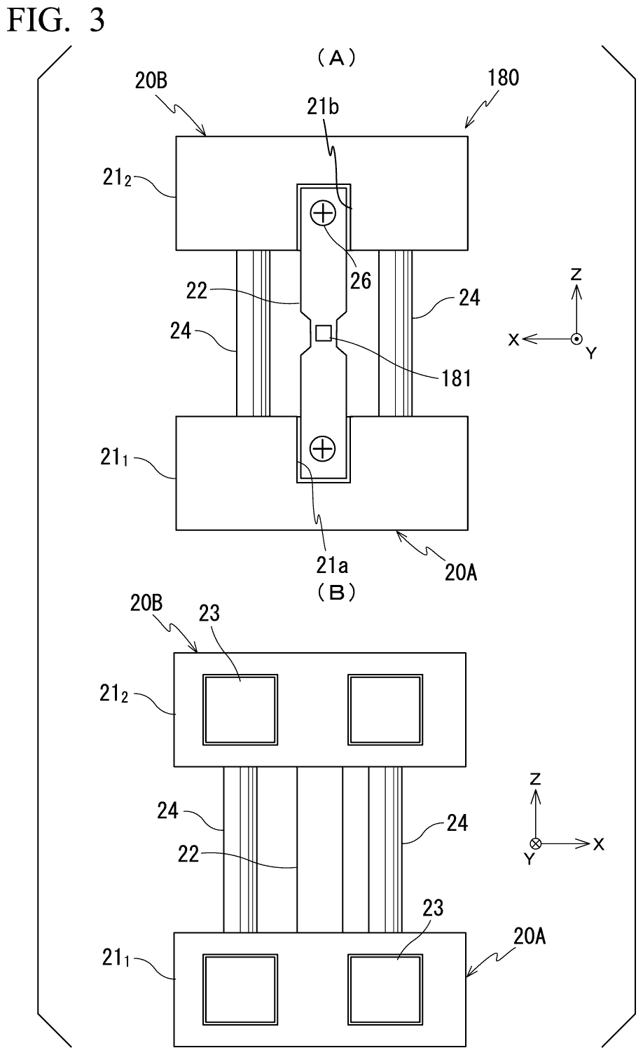

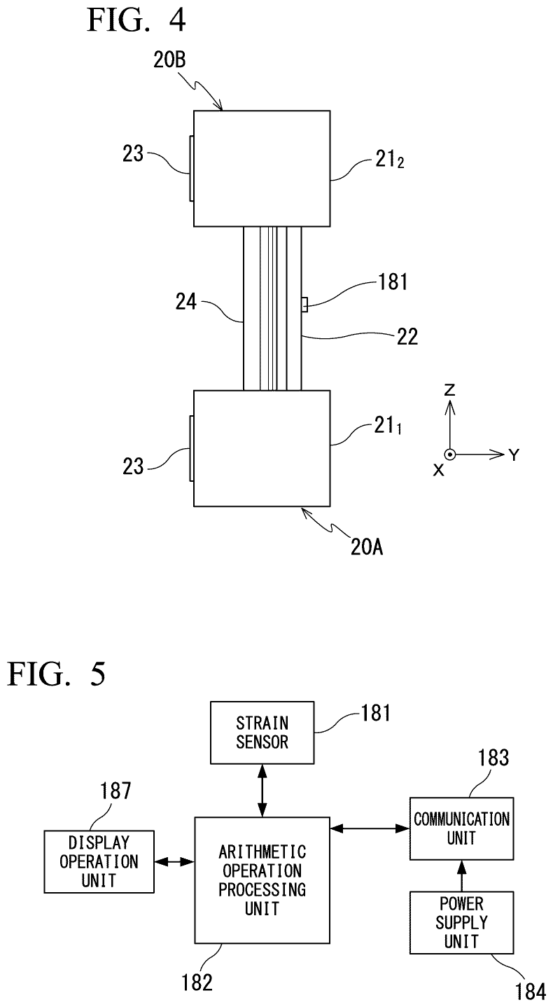

Next, the configuration and the like of the measurement device 18ᵢ will be described. The measurement device 18ᵢ is a measurement device that measures strain (deformation information) of a measurement target and has an object formed from a magnetic material set as a measurement target in this embodiment. FIGS. 2 to 4 illustrate the measurement device 18ᵢ. Among these, FIG. 2 illustrates a perspective view of the device main body 180 of the measurement device 18ᵢ together with a section column 100ⱼₚ that is a measurement target. In FIG. 2, a two-dot chain line to which reference numeral 185 is attached represents a casing that represents the device main body 180. Part (A) of FIG. 3 illustrates a plan view (a view seen in the +Y direction in FIG. 2) of the device main body 180, part (B) of FIG. 3 illustrates a bottom view (a view seen in the −Y direction in FIG. 2) of the device main body 180, and FIG. 4 illustrates a front view (a view seen in the +X direction in FIG. 2) of the device main body 180.

As illustrated in FIGS. 2 to 4, the device main body 180 includes one pair of magnet bases 20A and 20B disposed to be separated in a predetermined direction (the Z-axis direction (the direction of gravity) in FIG. 2, the vertical direction), a connecting member 22 formed from a metal plate member extending in a predetermined direction connecting the one pair of magnet bases 20A and 20B, and one pair of guide members 24.

One magnet base 20A has a main body part 21₁ having an approximately cuboid shape and two magnets 23 (FIG. 3 (see part (B))) disposed in the state of being embedded in two concave parts formed in a bottom face of the main body part 21₁. Similarly, the other magnet base 20B has a main body part 21₂ having an approximately cuboid shape and two magnets 23 (FIG. 3 (see part (B))) disposed in the state of being embedded in two concave parts formed in a bottom face of the main body part 21₂.

The magnets 23 respectively slightly protrude from bottom faces of the main body parts 21₁ and 21₂ of the magnet bases 20A and 20B (see FIG. 4). As the magnets 23, although rectangular magnets are used in this embodiment, the magnets are not limited thereto, and magnets having other shapes such as a circular shape and the like may be used. The shape of the concave parts may be configured to match the shape of the magnets.

In the main body part 21₁ of the magnet base 20A, a notch part 21a having a predetermined depth from a face of the +Y side and having a predetermined depth from a face of the +Z side is formed. In the main body part 21₂ of the magnet base 20B, a notch part 21b having a predetermined depth from a face of the +Y side and having a predetermined depth from a face of the −Z side is formed to face this notch part 21a. One end and the other end of the connecting member 22 are respectively inserted into the notch parts 21a and 21b from the +Y side and are disposed in the state of being in parallel with an XZ plane. One end and the other end of the connecting member 22 are respectively fixed to internal bottom faces of the notch parts 21a and 21b using screws 26 (see FIG. 3(A)).

A strain sensor 181 is fixed on one face of the center of the connecting member 22 in the longitudinal direction through bonding or the like. As the strain sensor 181, for example, a semiconductor strain sensor of a type in which a sensor element, an A/D converter, and peripheral circuits such as an amplifier and the like are mounted in a semiconductor chip is used.

One pair of guide members 24 are formed from rod-shaped members having a circular cross-section extending in the Z-axis direction, and one end (a −Z side end) of each thereof is fixed to an upper face of the main body part 21₁ of one (−Z side) magnet base 20A. The other end (a +Z side end) of each of the one pair of guide members 24 is in the state of being inserted into each of one pair of circular holes 21c (see FIG. 2) in the Z-axis direction formed in the main body part 21₂ of the other magnet base 20B from a lower side (−Z direction).

According to the device main body 180 configured in this way, when a force in a direction causing both the magnet bases 20A and 20B to approach each other (or a force in a direction separating them) is applied to at least one thereof, the magnet base 20B slightly moves in a direction approaching (or a direction away from) the magnet base 20A along one pair of guide members 24. Simultaneously with this, the force described above acts as a compression power (or a drawing force) on the connecting member 22, and the length of the connecting member 22 changes. The strain (the strain in the direction of gravity) of the connecting member 22 corresponding to the change of the length is measured by the strain sensor 181. The strain is defined as a ratio of the amount of change (the amount of deformation) ΔL of the length of an object to the original length L of the object. Thus, strain is a dimensionless number without units. In this specification, a measured value or calculated value of strain will be referred to as a strain value as is appropriate. In addition, strain can also be referred to as a deformation ratio.

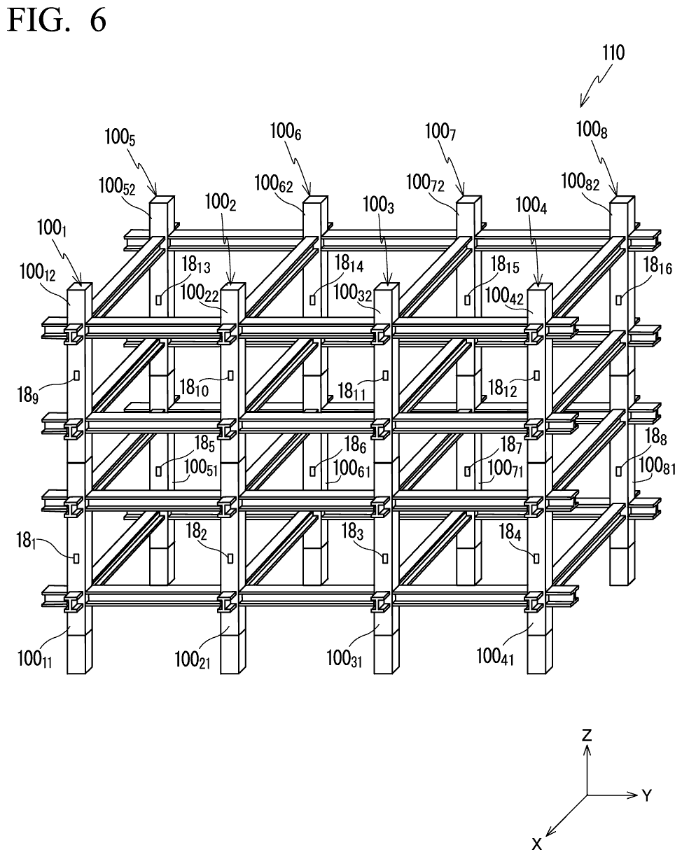

In this embodiment, each of the measurement devices 18ᵢ has steel-frame columns (hereinafter, referred to as columns) 100ⱼ (j=1, 2, 3, . . . ) configuring a steel-frame building 110 of which one example is illustrated in FIG. 6 as measurement targets. While one column is formed by joining (bonding) a plurality of (a plurality of sections of) columns, hereinafter, one column formed through bonding will be referred to as a column, and a column of each section will be referred to as a p-section column by assigning a number p of a section column or a section.

In this embodiment, as illustrated in FIG. 6, one measurement device 18ᵢ is attached to one section column. The measurement device 18ᵢ can be attached to a measurement target with a one-touch operation through magnetic adsorption using the magnets 23 of one pair of magnet bases 20A and 20B. The measurement device 18ᵢ is attached to a section column in a state in which the direction of separation of one pair of magnet bases 20A and 20B coincides with a longitudinal direction of the section column. In this embodiment, for each section, an attachment position of the measurement device 18ᵢ is set at a position with almost the same height as that of a center part of the section column in a height direction (for example, a center part in a case in which the section column is divided into three parts of a column head part, the center part, and a middle leg part).

FIG. 5 illustrates the configuration of a control system of the measurement device 18ᵢ using a block diagram. The control system includes a strain sensor 181, an arithmetic operation processing unit 182, a communication unit 183, a power supply unit 184 formed using a battery, and a display operation unit 187.

The arithmetic operation processing unit 182, for example, is configured using a micro-processing unit (MPU) (microprocessor). The MPU is an IC having the same structure as a computer having a CPU, a memory device (memory), and the like. The arithmetic operation processing unit 182 executes a processing algorithm that is defined by a program stored in the memory device. The arithmetic operation processing unit 182 assigns identification information (ID) of the measurement device 18ᵢ to measurement information of a strain value output from the strain sensor 181 and supplies resultant measurement information to the communication unit 183 as one piece of sensor data. The arithmetic operation processing unit 182 also performs control of the entire measurement device 18ᵢ. In addition, without disposing the arithmetic operation processing unit 182 separately from the strain sensor 181, an ASIC built into the strain sensor 181 may be configured to have the function of the arithmetic operation processing unit 182 as well. One piece of sensor data is not limited to integrated data, and a plurality of pieces of information included in one piece of sensor data (for example, measurement information of a strain value and identification information) may be associated with each other.

The communication unit 183 functions as a Wi-Fi communication (wireless LAN communication) unit as one example in this embodiment. The measurement device 18ᵢ can perform wireless LAN communication with the server 12 through the network 13 or other devices connected to the network 13. The sensor data described above is output from the communication unit 183 to the server 12 through the network 13. In addition, a part of the communication unit 183 may be configured using a wired communication unit.

The arithmetic operation processing unit 182, the communication unit 183, and the power supply unit 184 are covered with a casing 185 having water resistance (see FIG. 2) together with the device main body 180. In the casing 185, a configuration not disturbing movement of the magnet base 20B in the Z-axis direction is employed.

In this embodiment, on/off of supply of power from the power supply unit 184 to each unit is configured to be performed using a remote operation from the outside (for example, the server 12, the field-side computer 14, the mobile terminal 16, or the like). The configuration is not limited thereto, and a power switch that can be used for manual on/off may be disposed in the casing 185. The power supply may be configured not to perform on/off.

The display operation unit 187, for example, is configured using a small touch panel (display) and is attached to the casing 185 in a state in which an opening portion formed on the surface (a face of the +Y side in FIG. 2) of the casing 185 is covered from the inner side. The touch panel is an electronic component acquired by combining a display device such as a liquid crystal panel and a position input device such as a touch pad and is an input device that operates a device by tapping on display on the screen. In addition, the measurement device 18ᵢ may include sensors other than the strain sensor 181, for example, such as a temperature and humidity sensor or an impact sensor. The display operation unit 187, for example, is used in a case in which information for identifying an attachment position of the measurement device is input by a worker at the time of initial setting of the measurement device 18ᵢ and the like. In this embodiment, after the measurement device 18ᵢ is attached to a section column that is a measurement target, when power is input through the mobile terminal 16 by a worker, an input screen for information for initial setting is configured to be displayed on the screen of the display operation unit 187. In addition, the display operation unit may not be disposed, and, in this case, as an example, information relating to the attachment position and the like may be input from a mobile terminal or the like through the network 13. Furthermore, the touch panel may not be necessarily disposed, and an operation for the measurement device may be remotely performed through a network.

In this embodiment, by attaching one measurement device 18ᵢ to each section column that is an attachment target to the same portion for any section column, it is sufficient that information for identifying an attachment position of the measurement device is information for identifying the section column that is the attachment target (for example, a column number and a section number). However, in a case in which an attachment portion is different for each section column, the information for identifying an attachment position of the measurement device needs to also include information for identifying the attachment portion. The information for identifying an attachment position of the measurement device that has been input is stored in a memory (for example, a RAM) by the CPU of the arithmetic operation processing unit 182. In addition, information of a section column to which the measurement device is to be attached (for example, a column number and a section number) and information for identifying an attachment portion for each section column can be altogether referred to as attachment information of the measurement device. Hereinafter, for each measurement device, an ID (an identification code) is attached to (associated with) management information in which information for identifying the measurement device (a device number or the like) and attachment information of the measurement device are organized, and ID information (including at least the management information and the ID) together with an attachment completion notification or also serving as an attachment completion notification is transmitted to the server 12. In this embodiment, although initial setting is completed by transmitting the ID information described above to the server 12 using a measurement device or a terminal (any kind of PC, a smartphone, or the like) connected to a network after a worker or the like attaching an arbitrary measurement device to an arbitrary section column, a worker or the like may pick up a designated measurement device in accordance with an instruction document (including the ID information described above) and attach the measurement device to a portion of a designated section column. In this case, although initial setting (generation and transmission of ID information) may not be necessarily performed, in other words, only a notification indicating completion of attachment of the measurement device to the server 12 may be transmitted to the server 12. The reason for this is that details (ID information and the like) of the instruction document are stored in the server 12. However, after attachment of the measurement device, similar to this embodiment, the ID information (at least the management information) may be configured to be transmitted to the server 12. In this case, the server 12 can check presence/absence of an attachment mistake and the like of the measurement device according to a worker or the like, and an operation mistake can be eliminated. In a case in which an attachment mistake has been confirmed, the server 12 enables a worker or the like to perform re-attachment of the measurement device by outputting a warning (for example, a sound, light, a text, or the like) to the measurement device or a terminal (a PC, a smartphone, or the like). The instruction document may be a paper sheet on which ID information and the like are printed or may be display of at least a part (including attachment information) of the ID information in the display operation unit 187 of the measurement device.

When attachment of the measurement device 18ᵢ to a measurement target (a section column) and initial setting end, an ID of the measurement device 18ᵢ is generated by the arithmetic operation processing unit 182 of the measurement device 18ᵢ, and information notifying an indication of the end of the initial setting (including the generated ID) is transmitted to the server 12. The ID includes a device number that is unique to a measurement device and information for identifying an attachment position of the measurement device (the attachment information described above). The device number is written into the memory of each measurement device 18ᵢ in advance in the stage of factory shipment. In this embodiment, a relation between the attachment position of each measurement device 18ᵢ (that is, a column number and a section number, and a portion as is necessary) and a device number (an identification number that is unique to the measurement device) is managed by the server 12.

In addition, the control system of the measurement device 18ᵢ is not limited to the configuration of this embodiment, and the control system of the measurement device 18ᵢ may include a sensor unit including the strain sensor 181, may connect the strain sensor 181 and other units other than the strain sensor 181 (including the arithmetic operation processing unit 182 and the like) using a wireless or wired communication line, and may be configured to perform output of data from the strain sensor 181 through a communication line and power supply for the strain sensor 181. In this case, another unit does not need to be disposed for each control system, and a plurality of control systems may be connected to the other same unit through a communication line. In addition, the function of this other unit, for example, may be included in another terminal device such as the field-side computer 14.

If the measurement device 18ᵢ is configured such that the strain sensor 181 can detect a change in the gap (a change in the strain value of the connecting member) between one pair of magnet bases in accordance with expansion/contraction when a measurement target expands and contracts in the state of being magnetically adsorbed in a measurement target (a steel-frame column) by the magnets 23 of the magnet bases 20A and 20B, the configuration of the device main body of the measurement device is not particularly limited.

Here, while the description will be out of order, a method for obtaining an amount of expansion/contraction (an amount of reduction or an amount of deformation in the direction of gravity) of a measurement target (a section column) using the measurement device 18ᵢ will be described.

A strain value (a measurement value) measured by the strain sensor 181 at the time of initial measurement, that is, an initial value of the strain value will be denoted by ε₀, and a strain value (a measurement value) measured by the strain sensor 181 at the time of measurement of an amount of expansion/contraction after the time of initial measurement will be denoted by ε₁. Here, after a measurement target (a section column) is erected, immediately after the measurement device 18ᵢ is attached to the section column, and the initial setting is performed, as will be described, measurement using the measurement device 18ᵢ is performed, and the time of initial measurement represents the time of the first measurement thereof. Here, a timing at which initial measurement is performed may be before loading a structure of an upper floor on a lower section column such as an upper section column after the measurement device 18ᵢ is fixed to a measurement target, and the initial measurement does not be necessarily performed immediately after fixation of the measurement device 18ᵢ. An initial value (an initial measurement value) may be an initial measurement value of which the time is the earliest among measurement values measured at different timings.

When a (mutual) gap between one pair of magnet bases 20A and 20B at the time of initial measurement is denoted by d₀, it can be represented as d₀=k·ε₀. Here, k is a proportional constant. k can be obtained through experiments or simulations. By obtaining a piecewise linear graph representing a relation between the strain value of the connecting member 22 measured by the strain sensor 181 and the gap between one pair of magnet bases 20A and 20B and fitting (linearly approximating) it by a first-order straight line, the slope of the first-order straight line can be obtained as the proportional coefficient k.

In addition, when the gap between one pair of magnet bases 20A and 20B at the time of measurement is denoted by d₁, it can be represented as d₁=k·ε₁.

From this, when the strain value of the portion of the section column, which is a measurement target, to which the measurement device 18ᵢ is attached is denoted by ε, ε can be represented in the following equation.

$$ε = k ( {ε}_{1} - {ε}_{0} ) / ( k \cdot {ε}_{0} ) = ( {ε}_{1} - {ε}_{0} ) / {ε}_{0} \qquad ( 1 )$$

Thus, when the length of the section column in the initial state is denoted by Lₚ, the amount of expansion/contraction ΔLₚ of the section column is represented in the following equation.

$$Δ {L}_{p} = {k}_{p} \cdot {L}_{p} \cdot ε = {k}_{p} \cdot {L}_{p} \cdot ( {ε}_{1} - {ε}_{0} ) / {ε}_{0} \qquad ( 2 )$$

In Equation (2) represented above, kₚ is an adjustment coefficient determined in accordance with a portion of a section column to which the measurement device 18ᵢ is attached. While the subscript p of Lₚ is a section number of a section column, in this embodiment, the lengths of section columns of the same section are the same, and, as described above, for a section column of any section, the attachment position of the measurement device 18ᵢ is set to the position of the center part in the height direction, and thus the adjustment coefficient kₚ=1 can be configured regardless of the value of p. In other words, ΔLₚ can be represented in the following equation.

$$Δ {L}_{p} = {L}_{p} \cdot ε = {L}_{p} \cdot ( {ε}_{1} - {ε}_{0} ) / {ε}_{0} \qquad ( 2 a )$$

Different from this, in a case in which the attachment position is set to the column head part for a column of any section, the adjustment coefficient kₚ at that section needs to be set to a predetermined value smaller than 1, and, in a case in which the attachment position is set to the column leg part, the adjustment coefficient kₚ at that section needs to be set to a predetermined value larger than 1.

For example, when a case in which one section column is equally divided into three parts including a column head part, a center part, and a middle leg part is considered, a self-weight of the column head part acts on the center part as a compressive force, a sum of the self-weight of the column head part and a self-weight of the center part acts on the column leg part as a compressive force, and there is no action of a compressive force according to a self-weight on the column head part. Based on such consideration, as represented in Equation (2) described above, an adjustment coefficient kₚ of a case in which ΔLₚ is obtained from the strain value ε is determined. However, the adjustment coefficient kₚ may be determined based on a result of structure analysis using various kinds of design information.

Here, as is apparent from Equation (1) described above, in a case in which the measurement device 18ᵢ is used in obtaining a strain value ε of a portion of the section column, which is a measurement target, to which the measurement device 18ᵢ is attached, the proportional coefficient k described above does not need to be actually obtained. However, in a case in which a piecewise linear graph representing a relation between the strain value measured by the strain sensor 181 and the gap between one pair of magnet bases 20A and 20B cannot be approximated by a first-order straight line with high accuracy, an approximation function of a second or higher order representing the relation may be obtained.

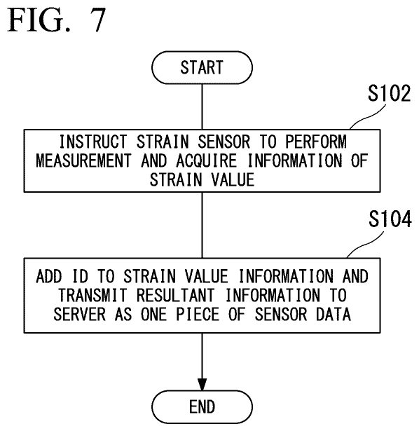

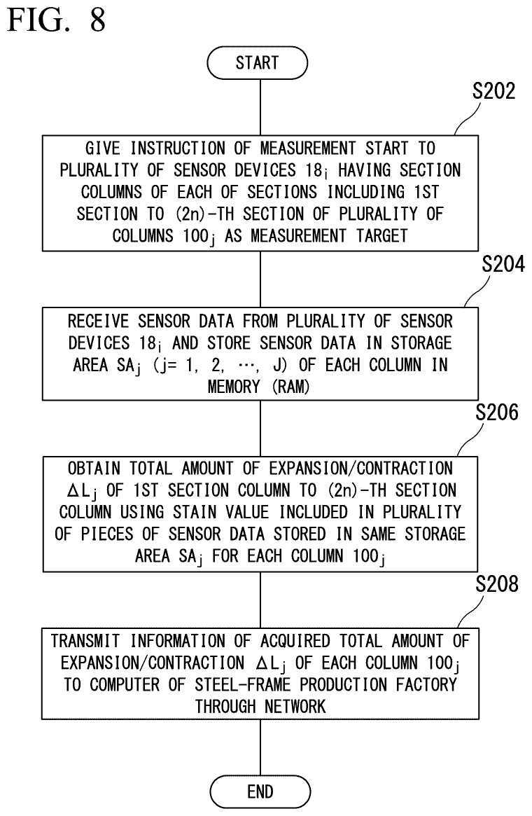

Next, the operation of each measurement device 18ᵢ will be described based on a flowchart illustrated in FIG. 7. The flowchart represented in FIG. 7 illustrates a processing algorithm according to a program that is executed by the CPU of the arithmetic operation processing unit 182. The processing algorithm illustrated in this flowchart starts when a measurement start instruction is input from the server 12. The measurement start instruction is given from the server 12 to the measurement device 18ᵢ at the time of initial setting of each measurement device 18ᵢ and at the time of measurement after initial setting (for example, at the time of measurement executed according to a program (see FIG. 8) relating to measurement of the length of a column to be described below).

Although the initial setting of the measurement device 18ᵢ is formed at the time of attachment of the measurement device 18ᵢ to a measurement target (a section column), at this time, information such as a column number, a section number, and the like is input to the measurement device 18ᵢ through the display operation unit 187 by a worker, and the arithmetic operation processing unit 182 generates an identification code (ID) based on the input information and a device number that is unique to the measurement device and transmits information (including the generated ID) for notifying an indication of the end of the initial setting to the server 12. The server 12 that has received this information, immediately thereafter, gives a measurement start instruction to the measurement device 18ᵢ.

On the other hand, at the time of measurement after initial setting, as described below, before the start of the measurement, a measurement instruction command is input from the mobile terminal 16 or the field-side computer 14 to the server 12, and the server 12 gives a measurement start instruction to the measurement device 18ᵢ in response to input of the measurement instruction command (see Step S202 to be described below).

First, in Step S102, an instruction for measurement is given to the strain sensor 181, and information of a strain value measured by the strain sensor 181 is acquired.

In next Step S104, an ID (an identification code) is assigned (associated with) to the acquired output information, and resultant information is transmitted to the server 12 through the communication unit 183 and the network 13 as one piece of sensor data. As the ID, a number (code) generated based on ID information (identification information) that has been input by a worker at the time of initial setting and is stored in a RAM is used in this embodiment. For example, as illustrated in FIG. 6, in a case in which the measurement device 18₁ is assumed to be attached to a one-section column 100₁₁ of a column 100₁, 001 to 001-01 are used as IDs. Here, the first “001” represents a device number that is unique to the measurement device, the next “001” represents a column number of the column 100₁, and “01” represents a section number. However, the ID does not be necessarily generated on the measurement device 18ᵢ side based on input from a worker, and, for example, the server 12 may generate ID information. In such a case, the server 12 displays a column number and a section number on the screen of the display operation unit of the measurement device 18ᵢ before attachment of the measurement device 18ᵢ or at the time of attachment thereof, and a worker may check the column number and the section number displayed on the screen and perform attachment of the measurement device 18ᵢ in accordance therewith. In this case, since the server 12 has a plurality of measurement devices 18ᵢ as management targets, it is essential to identify each measurement device 18ᵢ as a prerequisite of display of the ID information. Thus, for example, together with a communication establishment request from the measurement device 18ᵢ to the server 12 at the time of power on, a request for transmission of ID information may be performed for the server 12. Alternatively, for example, a device number that is unique to the measurement device may be set in advance in the stage of manufacturing the measurement device or the like.

When the process of Step S104 ends, the process ends. In accordance with this, the measurement device 18ᵢ comes into a standby state until a next measurement start instruction is input.

At the time of initial setting (immediately after the end of setting) of each measurement device 18ᵢ, by using the measurement device 18ᵢ (the CPU of the arithmetic operation processing unit 182), the process is performed in accordance with Steps S102 to S104 described above, and sensor data (including information of the initial value of a strain value measured by the strain sensor 181 and an ID) are output to the server 12.

The server 12 acquires the initial value of the strain value measured by each of all the measurement devices 18ᵢ and stores the initial values in the memory.

In a general steel-frame building, in order to configure the ceiling height of each floor to be constant, a design value of the length (height) of a column of each section is adjusted. On a column of a certain section positioned on the lower side, weights of columns, beams, and the like of sections disposed on an upper side thereof act as a compressive force, and thus the dimension of the column in the longitudinal direction (the height direction) reduces. The amount of reduction becomes larger for a section of a lower side and becomes smaller for a section of an upper side. By taking this into account, the design value of the length of the section column of each section is set by assuming that the section column is shortened by a “predetermined amount” for each section.

In this embodiment, as one example, the “predetermined amount” described above is assumed to be 0.001 (m). In a building of N sections, the designed values are set such that the length of the p-th section column becomes 12+0.001×(N−p) (m) with the reference length as 12 (m). In this case, when the column of each section is shortened by 0.001×(N−p) (m) as the designed values, the column of any section can secure the reference length.

However, in an actual building, even if each section column is manufactured with a length that is the same as the designed value, the length of each section column and the length of the column after the end of erection of the building are not as the designed values.

Thus, in this embodiment, as one example, prior to start of erection of an upper section thereof, that is, an (2n+1)-th section in a stage in which erection of an even-numbered section (the (2n)-th section (here, n is a natural number)) ends, measurement of the length of the column for adjusting the length of an upper section column is performed.

FIG. 8 illustrates a flowchart representing a processing algorithm corresponding to a program relating to measurement of the length of a column that is executed by the CPU of the server 12. Hereinafter, the flowchart illustrated in FIG. 8 will be described.

When a measurement instruction command is input from the mobile terminal 16 or the field-side computer 14 to the server 12, the processing algorithm represented in the flowchart illustrated in FIG. 8 starts. Generally, the mobile terminal 16 is operated by a field worker, and the field-side computer 14 is operated by a field director or any other field manager.

First, in Step S202, a measurement start instruction is given to a plurality of measurement devices 18ᵢ that have section columns of 1st to (2n)-th sections of a plurality of columns 100j (j=1 to J) as measurement targets. For example, as in the building 110 illustrated in FIG. 6, when erection of the 2nd section (the (2n)-th section in case of n=1) including a plurality of columns 100ⱼ (j=1 to 8) ends, a measurement instruction command is given to the measurement devices 18ᵢ (i=1 to 16) having the 1st section column and the 2nd section column of the column 100ⱼ as measurement targets. In FIG. 6, reference sign 100ⱼₚ (here, j is one of 1 to 8; p is 1 or 2) represents each section column, and, in the subscript “jp” of the reference sign 100ⱼₚ, “j” represents the number of a column, and “p” represents a section number. For example, a section column represented by reference sign 100₁₁ is a first section column configuring the column 100₁.

At a time point at which the process of Step S202 is performed, the measurement device 18ᵢ is attached to each of section columns of the first section to the (2n)-th section of each column 100j (see the measurement devices 18₁ to 18₁₆ illustrated in FIG. 6). For each measurement device 18ᵢ, the initial setting described above ends, and the measurement device 18ᵢ is in the standby state described above. In addition, sensor data output from each measurement device 18ᵢ at the time of initial measurement after end of initial setting is stored in a storage area SAⱼ (here, j=1, 2, . . . , J (J=8 in FIG. 6)) of each column inside the memory (RAM) of the server 12. Thus, a measurement value (an initial value of the strain value) ε₀ of the initial strain that is measured by the strain sensor 181 included in each measurement device 18ᵢ is known.

The plurality of measurement devices 18ᵢ to which the measurement start instruction described above has been given perform strain measurement (measurement using the strain sensor 181) along the flowchart illustrated in FIG. 7 described above and output sensor data including information of strain values (measurement values) to the server 12.

In the next Step S204, the sensor data from the plurality of measurement devices 18ᵢ is received, and each piece of the sensor data is stored in a storage area SAⱼ (here, j=1, 2, . . . , J) (J=8 in FIG. 6) for each column inside the memory (RAM) based on identification information of a column (a column number j) included in the sensor data. At this time, since data of initial values of the strain values of section columns of the first section to the (2n)-th section is stored in each storage area SAⱼ, corresponding sensor data received this time is stored in association with the data of the initial value of the strain value of each section column in Step S204.

In next Step S206, by using a strain value (a measurement value) included in each of a plurality of pieces of sensor data stored in the same storage area SAⱼ, for each column 100ⱼ of a column number j (here, j=1−J (J=8 in FIG. 6)), a total amount ΔLⱼ of expansion/contraction of the section column of the first section to the (2n)-th section (the previous section) is obtained. The total amount ΔLⱼ of expansion/contraction can be obtained as below.

First, by using the initial value co of the strain value associated with each of the first section column 100ⱼ₁ to the (2n)-th section column 100ⱼ₂ₙ and a latest strain value ε₁ included in the sensor data newly stored in Step S204, which are stored in each storage area SAⱼ (here, j=1 to J (J=8 in FIG. 6)), the arithmetic operation of Equation (2a) described above is performed, and the strain value εⱼₚ (here, j=1 to J; p=1 to 2n) of each section column is obtained.

Then, by performing an arithmetic operation of the following Equation (3) using the obtained strain value εⱼₚ (j=1˜J, p=1˜2n) of each section column, a total amount ΔLⱼ of expansion/contraction is obtained for each column 100ⱼ (j=1 to J).

$$Δ {L}_{j} = \sum ( {ε}_{jp} \times {L}_{p} ) \qquad ( 3 )$$

In Equation (3) represented above, Σ represents a total of p=1 to 2n, and Lₚ is the length of the initial state of the section column of each section (generally, approximately coincides with a designed value). Here, for the same section of any column, the length of the column is assumed to be set to the same length in design. However, for the 2nd and subsequent sections, in accordance with the amount of reduction of a lower section column, the length of the column may be configured to be adjusted at the time of manufacturing. In this case, for columns (section columns) of the same section, a length corrected in accordance with the amount of reduction of a lower section column may be set for each column (the length may be updated in design data).

In the next Step S208, after information of the total amount of expansion/contraction of each column 100; (here, the amount of reduction) ΔLⱼ that has been obtained is transmitted to a computer of a steel-frame production factory through the network 13, a series of processes end. The transmission of the information of the total amount of expansion/contraction ΔLⱼ of Step S208 is performed after communication establishment between the computer of the production factory and the server 12.

The computer of the steel-frame production factory corrects and changes a design value of the length of the (2n+1)-th section column of the column 100ⱼ such that the entire length of the column after the end of erection of the (2n+1)-th section becomes a designed value based on the information of the total amount of expansion/contraction (the total amount of reduction) ΔLⱼ of the column 100ⱼ that has been received and displays the information representing the correction/change of the design value on the screen of the display. This display may be displayed together with a drawing that represents arrangement of each steel frame of a steel-frame building of a construction site. In addition, by feeding back reduction information to design CAD data, design values may be corrected (updated).

In the steel-frame production factory, the (2n+1)-th section column 100ⱼ₍₂ₙ₊₁₎ of the column 100ⱼ is produced based on the design value of the length after the correction/change, the produced (2n+1)-th section column is delivered to a construction site, and erection of the (2n+1)-th section is performed using the delivered (2n+1)-th section column. For an upper section column of the (2n+1)-th section ((2n+2)-th section column), the column is manufactured in accordance with a design value of the length that has been originally set.

In addition, in the description presented above, as one example, although, prior to start of erection of an upper section ((2n+1)-th section) in a stage in which erection of an even-numbered section, that is the (2n)-th section (here, n is a natural number) ends, measurement of the length of a column for adjusting the length of an upper section column is performed, the configuration is not limited thereto and, measurement of the length of a column for adjusting the length of an upper section column may be performed prior to start of erection of an upper section thereof (the (2n)-th section) in a stage in which an odd-numbered section, that is, the (2n−1)-th section (here, n is a natural number) ends, and measurement of the length of a column for adjusting the length of an upper section column may be performed prior to start of erection of each section that is the 2nd section or a subsequent section. Alternatively, in an arbitrary one section or multiple sections after the second section, prior to start of erection at that section, measurement of the length of a column for adjusting the length of an upper section column may be performed. In addition, in a section after the second section, every time a structure (including a section column, a beam, and the like) of an upper floor is added, the length of the section column at the time may be adjusted in accordance with an amount of reduction of a lower section column, or, reduction measurement is performed every time a structure (including a section column, a beam, and the like) of an upper floor is added, and only in a case in which the amount of deformation of a lower section column (in a case in which lower section columns of multiple sections are connected, a total amount of deformation thereof) exceeds a threshold, the length of a next section column (an upper section column) may be adjust before shipment. Furthermore, in the description presented above, although deformation of a section column according to an action of the force of gravity has been covered, and thus a case in which the measurement device 18ᵢ is mainly used in reduction measurement of a section column that is a measurement target has been described, the measurement device 18ᵢ can be used also in expansion measurement of a measurement target.

As described above, according to the measurement device 18ᵢ of this embodiment, by performing magnetic adsorption of one pair of magnet bases 20A and 20B into a measurement target (a steel-frame column in the embodiment described above), the measurement device 18ᵢ can be attached to the measurement target with a one-touch operation. Thus, in erection of a steel-frame structure including steel-frame columns of multiple sections, each measurement device 18ᵢ can be attached to multiple section columns of each section in a short time. In addition, according to the measurement device 18ᵢ, when a measurement target to which it is attached expands or contracts, a mutual gap between one pair of magnet bases 20A and 20B changes in accordance with the amount of expansion/contraction, and a strain value of the connecting member 22 that is measured by the strain sensor changes in accordance with the amount of change in the gap. Thus, according to the measurement device 18ᵢ, based on a difference between strain values measured before and after expansion/contraction of a measurement target by the strain sensor 181, the amount of change in the mutual gap between one pair of magnet bases (and a strain value of an attachment target corresponding to this) can be obtained.

In addition, the measurement device 18ᵢ according to this embodiment includes the arithmetic operation processing unit 182 that is connected (or built into) the strain sensor 181 and outputs information of a strain value (measurement information) output from the strain sensor and ID information (it may be only an ID) as one piece of sensor data. Thus, in erection of the steel-frame building or the like, in a case in which a plurality of measurement devices 18ᵢ are used, the measurement device 18ᵢ and sensor data can be associated with each other based on ID information included in each piece of sensor data. In addition, in a case in which the sensor data includes only an ID as the ID information, by using management information that is associated with the ID and is stored in the RAM, association between the measurement device and the sensor data can be performed. In accordance with this, information of strain values (measurement information) included in sensor data output from a plurality of measurement devices 18ᵢ can be effectively used.

In addition, in the measurement system 10 according to this embodiment, sensor data output from the measurement device 18ᵢ includes at least a part of the management information associated with an ID, for example, an identification number that is unique to the measurement device 18ᵢ and information for identifying an attachment position (a column number and a section number of a section column that is a measurement target in this embodiment) as ID information, and the sensor data is supplied to the server 12. In accordance with this, the server 12 can manage a relation between an attachment position (that is, a column number and a section number) of each measurement device 18ᵢ and a device number (an identification number that is unique to the measurement device). Thus, according to the measurement system 10 of this embodiment, the server 12 can identify a section column of a section of a column from which each piece of sensor data has been output, and measurement information measured by the plurality of measurement devices 18ᵢ (information of strain values (measurement values) measured by the strain sensor 181) can be effectively used.

In addition, according to the measurement system 10 of this embodiment, the server 12 acquires sensor data by performing measurement using (the strain sensor 181 of) each measurement device 18ᵢ at the time of initial measurement and at the time of measurement, can obtain a strain value ε of a section column that is a measurement target by performing the arithmetic operation of Equation (1) described above using the initial value ε₀ of the strain value and the measurement value (the strain value) ε₁ of strain included in each piece of the sensor data, and can obtain the amount of expansion/contraction ΔLₚ from the initial state at the time of measurement of the section column by further performing the arithmetic operation of Equation (2) or Equation (2a) described above using the obtained strain value ε and the length Lₚ of the initial state of the section column.

Furthermore, according to the measurement system 10 of this embodiment, for each column 100ⱼ (here, j=1 to J), prior to start of erection of a section column of the n-th (here, n≥2) section (the n-th column 100ⱼₙ), the server 12, for a section column 100ⱼₚ (here, j=1−J; p=1 to (n−1)) of a section of which erection has already ended, that is, for each lower section column up to the (n−1)-th section, can obtain a total amount of expansion/contraction ΔLⱼ, for example, through the arithmetic operation of Equation (3) described above by using the strain value Sip (here, j=1 to J; p=1 to (n−1)) using the technique described above (see Step S106).

Thus, in consideration of the obtained total amount of expansion/contraction, a design value of the length of the n-th section column 100ⱼₙ may be configured to be corrected and changed.

As is apparent from the description presented until now, by using the measurement system 10 according to this embodiment in erection of a steel-frame building, adjustment of the length of the section column for each column can be performed, and mutual height adjustment among a plurality of columns can be performed as well.

In addition, in the embodiment described above, although a case in which one measurement device 18ᵢ is attached to the position of the center part of one section column in the height direction has been described, the configuration is not limiter thereto, and a plurality of measurement devices 18ᵢ, for example, two or three measurement devices 18ᵢ may be attached to one section column. For example, in a case in which three measurement devices 18ᵢ are attached to one section column 100ⱼₚ, the section column is divided into three parts including a column head part, a column leg part, and a part between both the parts (a center part) in the height direction, and one measurement device 18ᵢ may be attached to the column head part, one measurement device 18ᵢ may be attached to the column leg part, and one measurement device 18ᵢ may be attached to the center part. In this case, the amount of expansion/contraction ΔLₚ of the section column 100ⱼₚ, for example, may be obtained based on the following Equation (4).

$$Δ {L}_{p} = {L}_{p} ( {ε}_{p 1} + {ε}_{p 2} + {ε}_{p 3} ) / 3 \qquad ( 4 )$$

In Equation (4) represented above, Lₚ is the length of the initial state of the section column 100ⱼₚ, and εₚ₁, εₚ₂, and εₚ₃ are respectively strain values of the column head part, the column leg part, and the center part of the section column 100ⱼₚ that are obtained from sensor data output from the measurement devices 18ᵢ attached to the column head part, the column leg part, and the center part.

In addition, as can be understood from the description presented until now, in the measurement system 10 and the method for erecting a steel-frame structure (a structure including columns of multiple sections) according to this embodiment, in erecting columns of second and subsequent columns, in order to correct and change a design value of the length of a section column of a new section (an upper section), for every even-numbered section, for every odd-numbered section, or for every section, measurement of strain values of all the lower section columns is repeatedly performed. Thus, until erection of a section column of a final section ends, the measurement device 18ᵢ attached to the section column once is maintained to be in the state of being attached to the section column that is a measurement target. Here, “being maintained” is not limited to a case in which each of all the measurement devices 18ᵢ attached to section columns once is maintained to be in the state of being attached to a section column that is a measurement target thereof. When an erected uppermost section that is an attachment target of a measurement device is an (n−1)-th section, in a case in which a plurality of measurement devices 18ᵢ are fixed to at least one section column (a predetermined section column), even when a structure (including a section column and a beam) of a further upper floor is stacked on the section column of the uppermost section (the (n−1)-th section), and the section becomes an (n−2)-th or less section, measurement devices 18ᵢ corresponding to the same number as that at a time when the uppermost section erected on the predetermined section column is the (n−1)-th section do not need to be fixed, and even a case in which at least one measurement device 18ᵢ is left in one section is included in “being maintained”. In addition, if prediction can be performed, the measurement device 18ᵢ may not be left in all of a plurality of columns (section columns) of the same section (floor).

In addition, the measurement target is not limited to a solid formed using a magnetic material such as a steel frame, and, for example, a solid to which a measurement device is not attached using a magnetic force may be set as a measurement target. In this case, a measurement device may be attached to the measurement target, for example, using screw fastening, pressing, vacuum adsorption, or the like other than a magnetic force.

### REFERENCE SIGNS LIST

10 Measurement system
12 Server
13 Network
18 Measurement device
20A, 20B Magnet base
22 Connecting member
100ⱼ Column
100ⱼₚ Section Column (measurement target)
181 Strain sensor
182 Arithmetic operation processing unit (control unit)
183 Communication unit
187 Display operation unit

1. A measurement device measuring deformation information of a measurement target for a predetermined direction that is parallel to a direction of gravity, the measurement device comprising:
one pair of attachment parts separated in the predetermined direction and being able to be fixed to the measurement target;
a connecting member connecting the one pair of attachment parts fixed to the measurement target and extending substantially parallel to the predetermined direction; and
a strain sensor fixed to the connecting member and measuring deformation information of the connecting member for the predetermined direction,
wherein the one pair of attachment parts are able to move apart or come close to each other in the predetermined direction in accordance with deformation of the measurement target for the predetermined direction in a state of being fixed to the measurement target.

2. The measurement device according to claim 1, wherein the strain sensor is mounted in a semiconductor chip.

3. The measurement device according to claim 1, further comprising a control unit that is built into or connected to the strain sensor and outputs the deformation information output from the strain sensor and identification information as sensor data.

4. The measurement device according to claim 3, further comprising a communication unit and a display operation unit that are connected to the control unit.

5. The measurement device according to claim 1,
wherein the measurement target is a magnetic material, and
wherein the one pair of attachment parts are fixed to the measurement target using a magnetic force.

6. A measurement system of a building constructed by stacking structures in a direction of gravity, the measurement system comprising:
management devices connected to each other through a network; and
a plurality of the measurement devices according to claim 1,
wherein each of the plurality of the measurement devices has a plurality of erected section columns as the measurement target and is fixed to the measurement target through the one pair of attachment parts in a direction in which the predetermined direction coincides with a longitudinal direction of the measurement target.

7. The measurement system according to claim 6,
wherein each of the plurality of the measurement devices further includes a communication unit and a display operation unit that are connected to the control unit, and
wherein the management device is connected to the communication unit of each of the plurality of the measurement devices through a network.

8. The measurement system according to claim 6, wherein sensor data output from each of the plurality of the measurement devices to the management device includes identification information that is unique to the measurement device and information used for identifying an attachment position of the measurement device as the identification information.

9. The measurement system according to claim 8, wherein the identification information unique to the measurement device is stored in the management device in association with information that is set in advance and is used for identifying the attachment position for each of the measurement devices.

10. The measurement system according to claim 6, wherein the management device acquires sensor data from a predetermined measurement device at the time of initial measurement after attachment of the measurement device to a section column that is a measurement target and at the time of measurement after that and obtains deformation information of the section column that is the measurement target through an arithmetic operation using the deformation information at the time of the initial measurement and the deformation information at the time of the measurement which are included in the sensor data.

11. The measurement system according to claim 10, wherein the initial measurement is performed at least once before a structure is loaded into the section column that is the measurement target.

12. The measurement system according to claim 10, wherein the management device, prior to start of erection of a section column of an n-th (n≥2) section, acquires sensor data from the measurement device having section columns of sections up to an (n−1)-th section of which erection has ended as a measurement target and corrects a design value of a length of the n-th section column based on the acquired sensor data.

13. The measurement system according to claim 6, wherein, until erection of a column of a final section ends, the plurality of measurement devices are maintained to be in a state of being attached to the section column that is the measurement target.

14. A method for erecting a structure including columns of multiple sections, the method comprising:
acquiring deformation information of lengths of section columns of sections up to an (n−1)-th section that becomes a lower section column with respect to an n-th section column of which erection has already ended based on a result of strain measurement of each lower section column up to the (n−1)-th section prior to erection of the predetermined n-th (n ≥2) section column;
correcting a design value of a length of the n-th section column with the acquired deformation information of all the lower section columns taken into account;
manufacturing the n-th section column based on the design value after correction; and
erecting the manufactured n-th section column on the (n−1)-th section column that is a lower section column with respect thereto.

15. The method for erecting a structure according to claim 14, wherein the method uses the measurement device according to claim 1,

16. The method for erecting a structure according to claim 14, wherein a strain sensor that is fixed to a deformable measurement member fixed to a measurement target is used in the strain measurement.

17. The method for erecting a structure according to claim 14, wherein the measurement device according to claim 3 having each lower section column as a measurement target is used in strain measurement of each lower section column up to the (n−1)-th section.

18. The method for erecting a structure according to claim 17, wherein, until erection of section columns of a final section ends, the measurement device is maintained to be in a state of being attached to a section column that is a measurement target.
